(19) United States
(12) Patent Application Publication
(10) Pub. No.: US 2006/0124796 A1
(43) Pub. Date: Jun. 15, 2006

(54) System and method for rolling flags

(76) Inventors: Oren Lynn Morgan, Burley, ID (US); Roger Lynn Morgan, Burley, ID (US)

Correspondence Address: Michael W. Starkweather, Suite 200, 9035 South 1300 East, Sandy, UT, 84094, US

(21) Appl. No.: 11/013,525

(22) Filed: Dec. 15, 2004

(51) Int. Cl. G09F 11/08; B65H 75/38

(52) U.S. Cl. 242/390.8; 40/514

(57) ABSTRACT

A system and method to furl and unfurl flags, or other sheet-like objects. The system, in one embodiment, includes a drive unit, a motor drive wheel attached to the drive unit, a sleeve attached to the motor drive wheel, a roller drum attached to the sleeve, and a sheet-like object attached to a length of the roller drum, such that actuation of the drive unit furls and unfurls the sheet-like object around the roller drum. The drive unit is configured to attach to a base, or a housing, which attaches to the base, while in another embodiment, on an opposite end, the roller drum rotatably attaches to the base, or the housing. The sheet-like object maybe a flag, or any other object capable of being furled and unfurled. Preferably, the drive unit is a tubular motor that fits within the sleeve. In another embodiment, a leader material may be used to display the entire flag from the housing. In yet another embodiment, a leveling means connected to the drive unit maybe used to evenly furl sheet-like objects of varying thickness, such as the American flag, to control the rate of furl and unfurl of sections of the sheet-like object.

### BACKGROUND OF THE INVENTION

1. Field of the Invention

This invention relates to a flag storage and display system, in particular, a motorized flag roller for rolling and unrolling flags.

2. Description of the Related Art

Gymnasiums, concert halls, convention centers, stadiums, and other structures are frequently used for large group meetings, school assemblies, and academic and professional sporting events, which are often prefaced with the pledge of allegiance. A flag is usually presented before the group at a front or central location of the structure and the group recites the pledge of allegiance or national anthem. Depending on the size of the gathering, the flag may range from a few square feet to hundreds, even thousands of square feet.

Patriotism and respect requires care in moving and storing the flag. Care should be taken to ensure that the flag is not dropped, dragged, or left in a location where the flag may become damaged. Accordingly, many procedures and devices have been used to ensure respect for the flag. In particular, some halyard systems use motors and timers to raise and lower the flag on a flagpole at specific times during the day, and to lower and raise the flag into a storage area during times of inclimate weather. Other geared systems utilize a complex drive system composed of threaded tubes, worm screws and gears, to roll and store the flag.

The prior systems serve a valuable purpose, however, they are deficient for a number of reasons. The halyard systems are cumbersome and are liable to suffer problems of rope breakage. The geared systems are complex, expensive to manufacture, prone to breakage due to sensitive moving parts, likely require greater maintenance, and due to the various layers of fabric from the flag stripes and sewn stars, the flag does not roll evenly.

In the alternative, to not use a system to display and protect the flag leaves the flag vulnerable to damage, as described above. Additionally, during large gatherings, it is inconvenient to pause the proceeding while an army of workers struggle to fold and pack the flag, especially for large flags. Finally, to leave the flag displayed after the pledge is completed, may hinder views of members of the group or interfere with the purpose of the gathering.

From the foregoing discussion, it should be apparent that a need exists for a system and method that efficiently and evenly furls and unfurls flags. Beneficially, such a system and method would protect the flag and improve the ability to use the flag for all kinds of situations without impeding views.

### SUMMARY OF THE INVENTION

The present invention has been developed in response to the present state of the art, and in particular, in response to the problems and needs in the art that have not yet been fully solved by currently available systems that furl and unfurl flags, or other sheet-like objects. Accordingly, the present invention has been developed to provide a system and method for furling and unfurling flags, or other sheet-like objects, that overcome many or all of the above-discussed shortcomings in the art.

A system of the present invention is presented to furl and unfurl flags, or other sheet-like objects. The system may be embodied with a drive unit, a motor drive wheel attached to the drive unit, a sleeve attached to the motor drive wheel, a roller drum attached to the sleeve, and a sheet-like object attached to a length of the roller drum, such that actuation of the drive unit furls and unfurls the sheet-like object around the roller drum. The drive unit is configured to attach to a base, or a housing, which attaches to the base, while in another embodiment, on an opposite end, the roller drum rotatably attaches to the base, or the housing. The sheet-like object maybe a flag, or any other object capable of being furled and unfurled. Preferably, the drive unit is a tubular motor that fits within the sleeve.

The sleeve, in another embodiment, includes at least one collar attached thereto. The collar has an outer surface diameter substantially equal to an inner surface diameter of the roller drum. The collar attaches to the inner surface of the roller drum. Advantageously, the sleeve and collar configuration allow for the application of various sized roller drums for various sized sheet-like objects, which allows a user to control the speed of the furling and unfurling by controlling the diameter.

In still another embodiment, a leader material may be used to attach the sheet-like object to the roller drum. The leader material allows the sheet-like object to extend completely from the housing.

In yet another embodiment, a system is presented to evenly furl and unfurl a sheet-like object of varying thickness, or composition. The system includes a drive unit, a roller drum, and a leveling means to control an effective diameter of a section of the roller drum to cause a portion of the sheet-like object of varying thickness or length, such as the American flag, to evenly furl and unfurl.

In other embodiments, the leveling means may be a roller drum and at least one protrusion extending from a surface of the roller drum, or it may be a wedge-shaped object, strip of material, other suitable object, attached to a roller drum or item being furled or unfurled. The protrusion, wedge, or other suitable object, is designed to increase the circumference of a section of the roller drum to increase the amount of furl or unfurl of a particular section of the sheet-like object with each rotation of the roller drum.

A method of the present invention is also presented to evenly furl and unfurl a sheet-like object of varying thickness, or composition. The method in the disclosed embodiments substantially includes the steps necessary to carry out the functions presented above with respect to the operation of the described system. In one embodiment, the method includes providing a drive unit and providing a leveling means rotatably connected to the drive unit for causing a section of the sheet-like object of varying thickness to furl and unfurl at a different rate than a different section of the sheet-like object.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a perspective view of a flag storage and display system according to one embodiment of the present invention;

FIG. 2 illustrates an exploded view of a flag storage and display system according to one embodiment of the present invention;

FIG. 3 illustrates a perspective view of a motor and sleeve according to one embodiment of the present invention;

FIG. 4 illustrates a cross sectional view of a flag storage and display system with a flag partially unfurled according to one embodiment of the present invention;

FIG. 5 illustrates a side view of a housing for a flag storage and display system according to one embodiment of the present invention;

FIG. 6 illustrates a front perspective view of a flag leveling system according to one embodiment of the present invention; and

FIG. 7 illustrates a front perspective view of an outboard motor for furling and unfurling a flag according to one embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

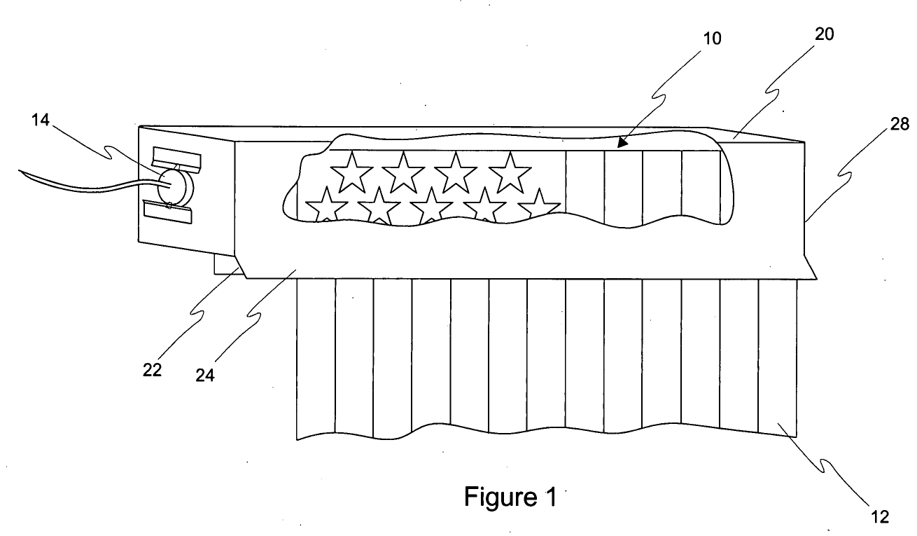

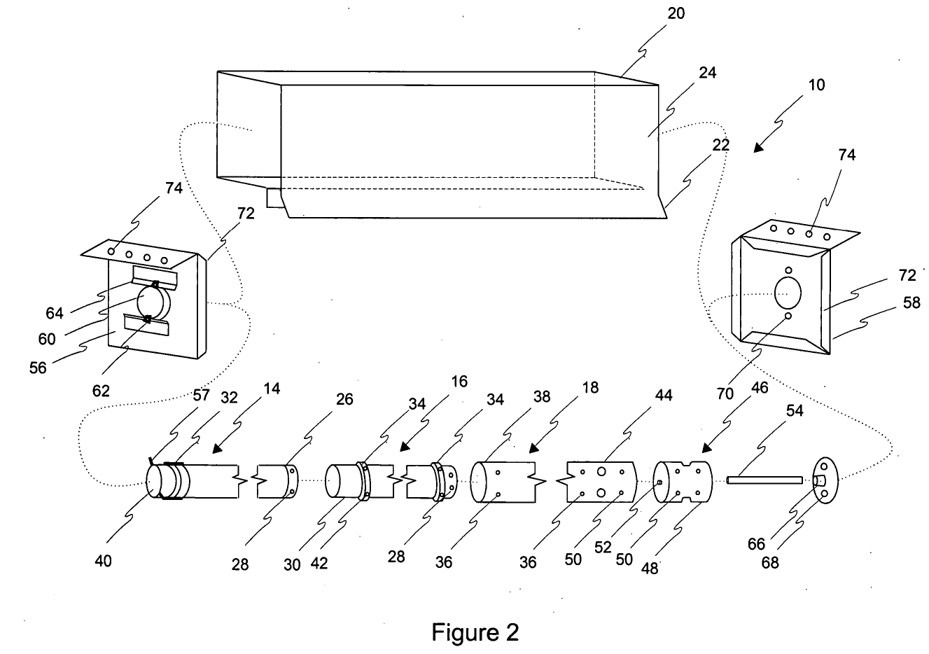

FIGS. 1 and 2 depict a perspective and exploded view of a system 10 designed to furl and unfurl a sheet-like object, or flag, 12. For illustration purposes, and as an example, not to be understood as limiting, the present disclosure will refer to the sheet-like object 12 as a flag. It is noted that the flag 12 may be any type of material; object, or form, capable of being furled and unfurled.

In one embodiment, the system 10 comprises a drive unit 14, a sleeve 16 attached to the drive unit 14, a roller drum 18 attached to the sleeve 16, and a flag 12 attached to the roller drum 18. The drive unit 14 furls and unfurls the flag 12 around the roller drum 18. In the illustrated embodiments, the system 10 is housed within a housing 20. The housing 20 may be configured to attach to a base (not shown), such as rafters of a gymnasium, convention center, ceiling, or walls of another structure. The housing 20 includes a slot (not shown) to allow the flag 12 to exit the housing 20 and unfurl from the roller drum 18. An optional lip 22 extends from a face side 24 of the housing 20 to facilitate furling and unfurling of the flag 12 and to strengthen the face side 24.

Referring specifically to FIG. 2, in one embodiment, the drive unit 14 is a tubular electric motor purchased from SIMU U.S. Inc. located at 6100 Broken Sound Parkway, N.W. in Boca Raton, Fla. 33487. The drive unit 14 includes a motor drive wheel 26, which rotatably turns to transfer rotational power to the sleeve 16. The sleeve 16 slides over the drive unit 14 and attaches to the motor drive wheel 26. A fastener (not shown), such as bolts, screws, or rivets, pass through fastener holes 28 to securely fasten the sleeve 16 to the motor drive wheel 26.

A first end 30 of the sleeve 16 forms a friction fit over a ring 32 to improve rotation of the sleeve 16. One skilled in the art would recognize that the sleeve 16 may attach to the ring 32 by any suitable means. Preferably, the ring 32 comprises a material with a low coefficient of friction. The ring 32 rotatably slides over a surface of the drive unit 14. A bearing (not shown) would also serve the purpose of the ring 32. The sleeve 16 may be any length.

At least one collar 34 attaches to the sleeve 16. The collar 34 has an outer surface diameter substantially equal to an inner surface diameter of the roller drum 18. A first end 38 of the roller drum 18 slides over the sleeve 16 and collars 34, leaving a first end 40 of the drive unit 14 exposed. Fasteners (not shown), such as bolts, screws, rivets, etc., attach the roller drum 18 to the collar 34. Specifically, the roller drum 18 includes holes 36, which correspond to collar holes 42, which receive the fasteners. As a result, the roller drum 18 fixedly attaches to the sleeve 16.

It is desirable to have an efficient furl and unfurl, preferably, a full furl or unfurl within sixty seconds. Accordingly, the roller drum 18 should be adapted to accommodate the preferred rate of furl and unfurl. As a result, the roller drum 18 may be any diameter greater than the diameter of the sleeve 16, or the motor drive wheel 26 in the absence of the sleeve 16 (to be discussed later). The sleeve 16 need only have a diameter greater than the diameter of the drive unit 14.

Advantageously, to provide an efficient furl and unfurl, according to one embodiment, either the collars 34 or the sleeve 16 can be removed and replaced with different sized collars 34 or sleeves 16. For example, if a very large flag 12 is to be used, the roller drum 18 may be longer than forty feet with a diameter greater than eighteen inches. The sleeve 16 is therefore configured with collars 34 having outer surface diameters equal to the roller drum's inner surface diameter. It is also envisioned that the entire sleeve 16 can be replaced to compensate for the diameter of the roller drum 18.

It is noted that in most circumstances the sleeve 16 need not be larger than the length of the drive unit 14, or the length of the distance between collars 34. As discussed previously, the collars 34 of the sleeve 16 are designed to securely attach the roller drum 18 to the sleeve 16. It is further noted, however, that for extremely large flags 12, a sleeve 16 with a multiplicity of collars 34 and longer than the drive unit 14 may be preferred to ensure a secure fix between the sleeve 16 and the roller drum 18.

A second end 44 of the roller drum 18 is configured to attach to the base 20. In the illustrated embodiment, the second end 44 of the roller drum 18 receives a support member 46, which slides into the second end 44. Flanges 48 substantially equal to the inner surface diameter of the roller drum 18 engage the inner surface and fasteners (not shown) pass through holes 50 to secure the support member 46 to the roller drum 18.

In most cases, the support member 46 need not be longer than twelve inches. The purpose of the support member 46 is to ensure that the roller drum 18 rotates substantially horizontal with respect to the drive unit 14. If the roller drum 18 sags, or if the support member 46 provides insufficient support, the roller drum 18 will not furl or unfurl the flag 12 effectively. Accordingly, one skilled in the art will recognize that the length of the support member 46 may be adjusted to accommodate larger and small roller drums 18.

A bearing 52, centrally located on one end of the support member 46 guides a support shaft 54, which ultimately supports the system 10 on the base or housing 20. The support shaft 54, in one embodiment, frictionally fits within the bearing 52. The support shaft 54 is slightly longer than the support member 46 to allow one end of the support shaft 54 to extend outwardly from the support member 46 to engage a support bearing 66 on housing end pieces 56 and 58, or to the base.

Preferably, the system 10 attaches to the first and second housing end pieces 56 and 58. With respect to the first housing end piece 56, the first end 40 of the drive unit 14 extends through a hole 60 in the first housing end piece 56. Protrusions 57, which protrude from the first end 40 of the drive unit 14 pass through holes 62 in driver support brackets 64. The driver support brackets 64 may be fastened to the first housing end piece 56 by well known fastening techniques. The driver support brackets 64 hold stationary the first end 40 of the drive unit 14 such that the motor drive wheel 26 rotates rather than the drive unit 14.

With respect to the second housing end piece 58, the support shaft 54 passes through the support bearing 66, which attaches to the second housing end piece 58. Holes 68 in the support bearing 66 align with holes 70 in the second housing end piece 58 to receive fasteners (not shown). The bearing 52 and the support bearing 66 allow the roller drum 18 to rotate to furl and unfurl the flag 12.

End piece flanges 72 of the first and second housing end pieces 56 and 58 attach the first and second housing end pieces 56 and 58 to the housing 20. It is noted that other well known fastening techniques may be used. Mounting brackets 74 attach the housing 20 to the base.

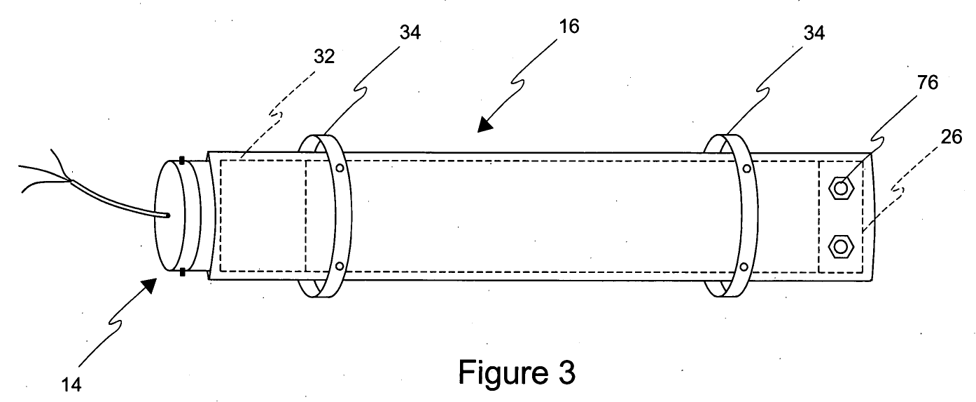

FIG. 3 illustrates the drive unit 14 inserted into the sleeve 16 according to one embodiment of the present invention. With the drive unit 14 inserted into the sleeve 16, the ring 32 and the motor drive wheel 26 engage the sleeve 16 and fasteners 76 secure the sleeve 16 to the motor drive wheel 26. The motor drive wheel 26 turns to transfer rotational power to the sleeve 16, which in turn, rotates the roller drum 18 (See FIG. 2).

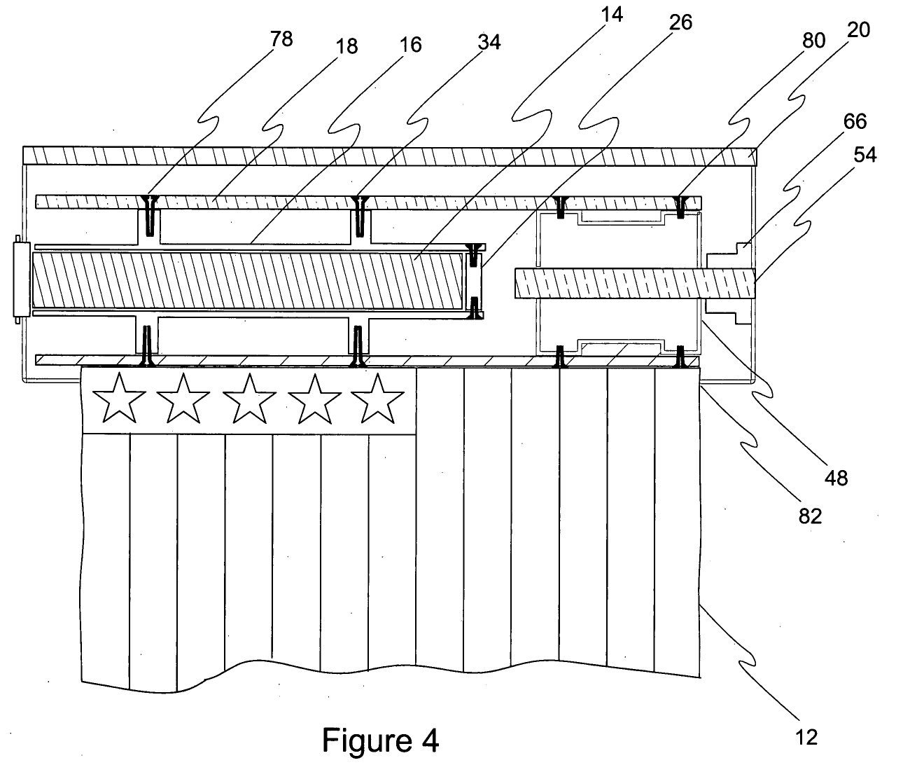

FIG. 4 illustrates a cross sectional view of the system 10 according to one embodiment of the present invention. The drive unit 14 attaches to the housing end piece 56. The sleeve 16 fits over the drive unit 14 and the ring 32 (See FIG. 2), and secures to the motor drive wheel 26. Fasteners 78 secure the roller drum 18 to the sleeve 16. Fasteners 80 attach the support member 46 (See FIG. 2) to the roller drum 18. The support shaft 54 passes through bearings 52 (See FIG. 2) and 66. Bearing 66 attaches to the second housing end piece 58.

In operation, actuation of the drive unit 14 causes the motor drive wheel 26 to turn, which rotates the sleeve 16 and the roller drum 18. The roller drum 18 furls and unfurls the flag 12 through a slot 82 in the housing 20.

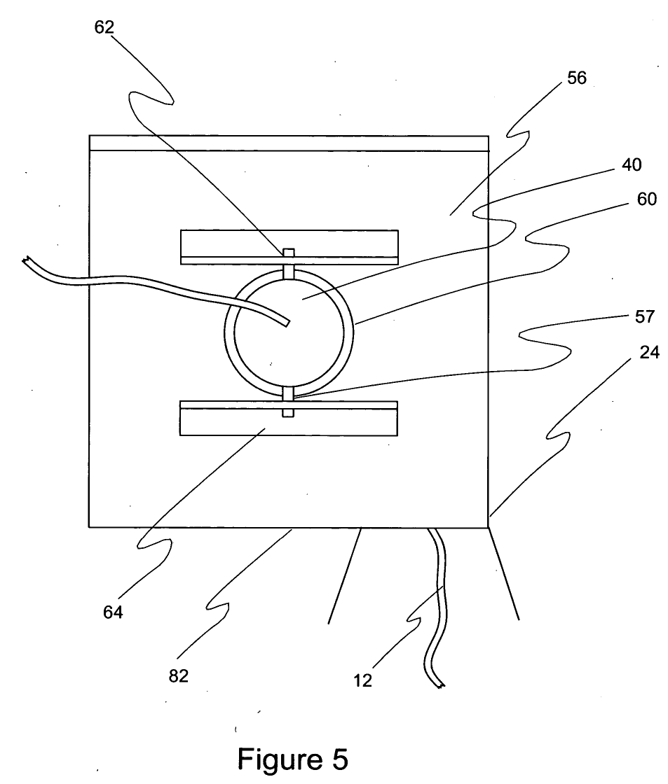

FIG. 5 illustrates a side view of the system 10 and housing 20 according to one embodiment of the present invention. The first end 40 of the drive unit 14 (See FIG. 2) extends through hole 60 of the first housing end piece 56. The protrusions 57 engage the bracket holes 62 of the driver support brackets 64 to hold the drive unit 14 in a fixed position. The drive unit 14 furls and unfurls the flag 12 through the slot 82.

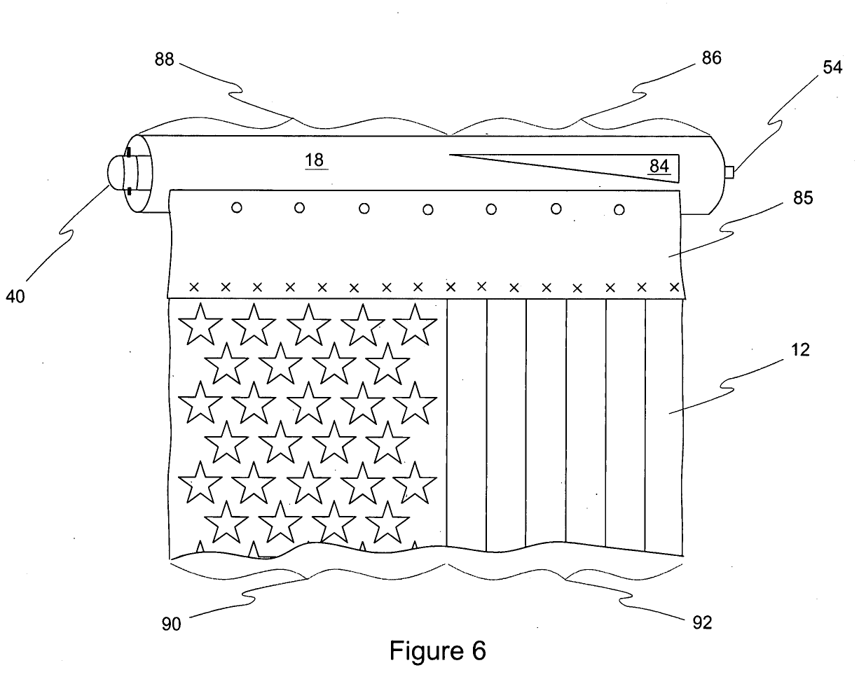

FIG. 6 illustrates a leveling means 84 and leader material 85 attached to the roller drum 18 according to one embodiment of the present invention. A common problem with systems designed to furl and unfurl flags is an uneven roll due to inconsistencies in material composition. The American flag is a perfect example, where the star section of the flag is much thicker than the striped area. This is because of the increased thread used to create the stars. When the flag rolls up, the flag begins to roll unevenly as the stars increase the rolling circumference. The problem propagates as the flag continues to roll, ultimately giving the rolled flag an unsightly appearance.

In one embodiment of the present invention, the leveling means 84 eliminates uneven rolling by increasing the overall circumference of a first section 86 with respect to a second section o88 f the roller drum 18 to compensate for a thicker portion 90 of the flag.

In the illustrated embodiment, the leveling means 84 is a wedge attached to the roller drum 18 or to the leader material 85. The wedge gradually decreases in size as it approaches the second section 88 of the roller drum 18. The gradual decrease in size of the wedge compensates for the thickness change of the flag 12 as it approaches the second section 88. It is recognized, however, that it is not necessary that the leveling means 84 be a wedge, as a square block, a strip of material, or other suitable object may be sufficient, depending on the thickness of the thicker portion 90 of the flag 12. The wedge may be constructed of any type of material, such as plastic, wood, metal, cardboard, etc. Additionally, the wedge may be fastened to the roller drum 18 or the leader material 85 with any type of fastener known in the art. Naturally, the length, width, and thickness of the leveling means 84 depends on the size of the flag 12 and the severity of varying thicknesses of the flag 12.

In another embodiment, the leveling means 84 comprises a plurality of protrusions (not shown) protruding from the roller drum 18. The protrusions, or studs, may be more pronounced at the extremities of the roller drum 18 and gradually decrease in size as they approach the thicker portion 90 of the flag.

The leader material 85 attaches to the flag 12 and to the roller drum 18. The leader material 85 may be any kind of flexible material, such as vinyl, plastic, fabric, etc. Any kind of fasteners or fastening material known in the art can be used to fasten the flag 12 to the roller drum 18. Additionally, the flag 12 may be sewn to the leader material 85, or fastened with fasteners or fastening material well known in the art. The leader material 85 acts to allow the flag 12 to completely unfurl from the housing 20 (See FIG. 2) to allow observers to see the entire flag 12. The leader material 85 is cut to a length to stay hidden within the housing 20.

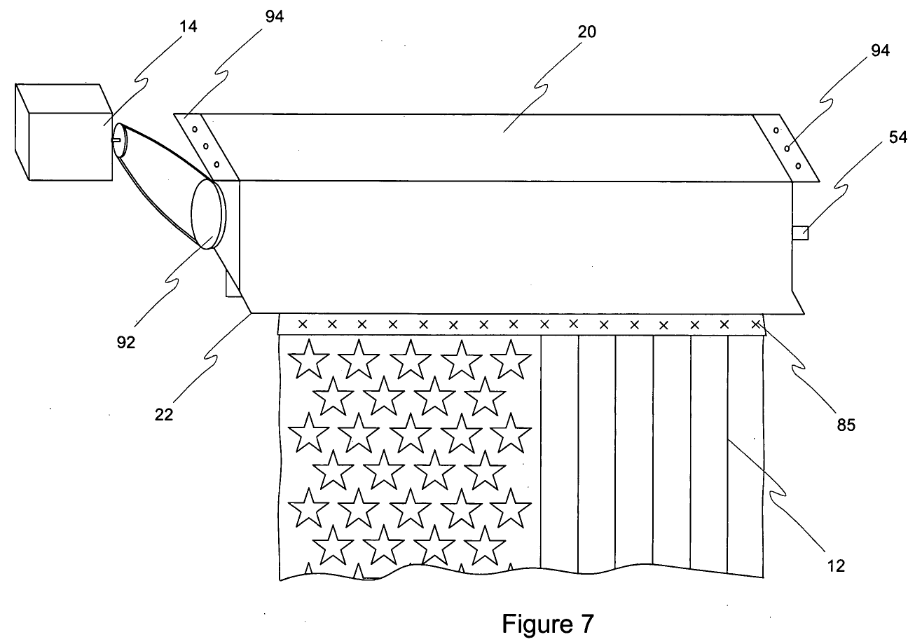

FIG. 7 illustrates a system with an external drive unit 14 according to one embodiment of the present invention. The drive unit 14 drives a drive wheel 92 which rotates the roller drum 18 (See FIG. 2) to furl and unfurl the flag 12. The leader material 85, in the illustrated embodiment, extends slightly from the housing 20 for illustration purposes only. However, preferably, the leader material 85 remains hidden within the housing 20. Brackets 94 can be used to secure the housing 20 to the base.

It is understood that the above-described arrangements are only illustrative of the application of the principles of the presently illustrated invention. The present invention may, however, be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the description and illustrations show the use of driver brackets 64 for fixing the drive unit 14 in a fixed position within the housing, it is also envisioned that any type of securing device may be used to fix the drive unit in a fixed position. For example, the protrusions 57 may be welded, screwed, or clamped to the first housing side piece 56.

Additionally, although the specification, and illustrated embodiments, teach and show the use of a sleeve 16 to attach to the drive unit 14 to compensate for various sized drum rollers 18, it is envisioned that the drum roller 18 can attach directly to the motor drive wheel 26 in the absence of the sleeve 16. For small projects involving the use of furling and unfurling small or short flags, such as for residential use, a large roller drum 18 may not be needed. Accordingly, the sleeve 16 can be removed and a small roller drum 18 can be attached directly to the motor drive wheel 26.

Although the description discusses the use of a support member 46 being inserted into the roller drum 18 to-provide support at a distal end of the roller drum 18 to the second housing side piece 58, it is envisioned that the support member 46 may be a cap or a piece of metal attached directly to the roller drum 18. The cap or the piece of metal may be adapted with a protrusion, which enters the bearing 66 similar to the support shaft 54 of the previous embodiments.

Additionally, although the specification discusses the use of a housing 20 for covering the system 10, it is envisioned that the system 10 may be attached directly to the base, structure, or wall without the housing 20. The housing 20 may include advertising information, or may be configured to display other information.

Furthermore, it is envisioned that any type of fastener may be used to attach the various components of the invention. Specifically, and not to be taken as limiting, the fasteners may be screws, bolts, glue, tape, welds, clamps, clasps, clips, hook and loop, and friction fit.

Still further, while the present invention discusses furling and unfurling a flag, it is envisioned that the system 10 may be configured to furl and unfurl all kinds of objects. For example, the present invention may be used to furl awnings, doors, windows, shades, etc.

The sleeve 16, roller drum 18, support member 48, housing 20, first and second housing side pieces 56 and 58, respectively, may be constructed out of any type of material capable of providing adequate support to the system 10 and flag 12. The material may be steel, aluminum, or any type of metal, composites, plastics, or wood, or a combination of any one of them.

It is further envisioned that the drive unit 14 may be any size adapted to be used with any size of flag. For larger sized flags 12, a larger drive unit 14 may be necessary. One skilled in the art will recognize that the drive unit 14 may be adapted for different sized flags.

It is further envisioned that the drive unit 14 may be any type of device capable of transferring power to rotate the roller drum 18. As an example, the drive unit 14 may use hydraulics or it may be a gas engine. One skilled in the art will recognize that there are many types of drive units 14 capable of performing the rotational function.

Finally, it is envisioned that the flag 12 may include a stabilizer attached to a bottom of the flag 12 to maintain the flag 12 visible and prevent the flag 12 from folding due to wind. The stabilizer may be plastic, composite, metal, or wood.

Thus, while the present invention has been fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A system to furl and unfurl a sheet-like object, the system comprising:
a drive unit, having a first end, a second end, and a motor drive wheel, wherein the first end secures to a base;
a sleeve attached to the motor drive wheel;
a roller drum, having a roller drum first and second end, the roller drum coupled to sleeve on the roller drum first end and rotatably attached to the base on the roller drum second end, the roller drum configured to rotate about its longitudinal axis;
a sheet-like object, having one side attached to a length of the roller drum; and
wherein actuation of the drive unit rotates the roller drum to furl and unfurl the flag.

2. The system of claim 1, wherein the drive unit includes a ring slidably coupled to the first end of the drive unit, and wherein the sleeve attaches to the ring and the motor drive wheel, such that rotation of the motor drive wheel turns the sleeve and ring.

3. The system of claim 2, wherein the ring comprises a material having a low coefficient of friction.

4. The system of claim 1, wherein the sleeve includes at least one collar attached to the sleeve, the collar having an outer surface diameter substantially equal to an inner surface diameter of the roller drum, and wherein the outer surface of the collar attaches to the inner surface of the roller drum.

5. The system of claim 1, wherein the sheet-like object is a flag.

6. The system of claim 1, wherein the drive unit is a tubular motor that fits inside the sleeve.

7. The system of claim 1, further comprising a housing to cover the roller drum and a furled sheet-like object, the housing configured with a slot to allow the sheet-like object to exit therefrom.

8. The system of claim 7, further comprising a leader material configured to attach to the sheet-like object on one side and to the roller drum on the other such that when the drive unit fully unfurls the sheet-like object through the slot, the sheet-like object is fully visible to an observer and the leader material remains hidden within the housing.

9. A system to furl and unfurl a sheet-like object of varying thickness, the system comprising:
a drive unit configured to attach to a base;
a roller drum; and
a leveling means for controlling an effective diameter of a section of the roller drum to cause a section of the sheet-like object of varying thickness to furl and unfurl at a different rate than a different section of the sheet-like object.

10. The system of claim 9, wherein the leveling means comprises at least one protrusion extending from a surface of the roller drum, the protrusion configured to increase the circumference of a section of the roller drum.

11. The system of claim 9, wherein the leveling means is a wedge attached to the roller drum and configured to increase the circumference of a section of the roller drum.

12. The system of claim 9, wherein the leveling means is a strip of material attached to a leader material, which is attached to the roller drum, and configured to increase the circumference of a section of the roller drum.

13. The system of claim 9, further comprising:
a motor drive wheel rotatably connected to the drive unit, the drive unit having a first end and a second end;
a sleeve attached to the motor drive wheel, and configured to support the leveling means;
a ring slidably coupled to the first end of the drive unit, and wherein the sleeve attaches to the ring and the motor drive wheel, such that rotation of the motor drive wheel turns the sleeve and ring.

14. The system of claim 13, further comprising a collar attached to the sleeve, the collar having an outer surface diameter substantially equal to an inner surface diameter of the roller drum, and wherein the collar attaches to the roller drum.

15. The system of claim 9, wherein the sheet-like object of varying thickness is a flag.

16. The system of claim 9, wherein the drive unit is a tubular motor.

17. The system of claim 9, further comprising a housing to house the drive unit and leveling means, the housing configured with a slot to allow the sheet-like object to exit therefrom.

18. The system of claim 11, wherein the leveling means attaches to the roller drum by means of a fastener.

19. The system of claim 12, wherein the leveling means attaches to the leader material by means of a fastener.

20. A method for furling and unfurling a sheet-like object of varying thickness comprising the steps of:
providing a drive unit configured to attach to a base; and
providing a leveling means rotatably connected to the drive unit for causing a section of the sheet-like object of varying thickness to furl and unfurl at a different rate than a different section of the sheet-like object.
